(19) United States
(12) Patent Application Publication
(10) Pub. No.: US 2025/0296753 A1
(43) Pub. Date: Sep. 25, 2025

(54) AGRICULTURAL PRODUCT PACKAGING MATERIAL AND METHOD FOR AGRICULTURAL PRODUCT PACKAGING MATERIAL PRODUCTION

(71) Applicants: NOK PARTICIPAÇÕES LTDA, Ribeirão Preto (BR); MINAS PACK FILMES E EMBALAGENS LTDA, Jacutinga (BR)

(72) Inventors: Denny OKUBO, Ribeirão Preto (BR); Aline Hurtado FIRMEZA, Jacutinga (BR)

(21) Appl. No.: 19/232,108

(22) Filed: Jun. 9, 2025

Related U.S. Application Data
(63) Continuation of application No. 17/271,661, filed on Feb. 26, 2021, now abandoned.

(30) Foreign Application Priority Data
Sep. 5, 2018 (BR) 1020180678671
Aug. 30, 2019 (BR) 1020190181281

(51) Int. Cl. B65D 75/52; B65D 65/14; B65D 65/20; B65D 81/24; B65H 18/28

(52) U.S. Cl. CPC B65D 75/527; B65D 65/14; B65D 65/20; B65D 81/245; B65H 18/28; B65D 2203/06; B65D 2203/10; B65D 2565/387

(57) ABSTRACT

A material for the packaging is for agricultural products. A single continuous film that is composed of a plurality of packaging portions, which are detachable from each other through a rupture line, said packaging portion being divided into an initial portion and a final portion, the latter portion being provided with a non-permanent adhesive layer on one of its surfaces. A method of making the material.

### CROSS-REFERENCE TO RELATED APPLICATIONS

This application is a continuing application of application Ser. No. 17/271,661, filed 26 Feb. 2021, which application is a national stage of international application no. PCT/BR2019/050361, filed Sep. 2, 2019, which claims priority to Brazilian application Ser. No. 1020180678671, filed Sep. 5, 2018, and Brazilian application Ser. No. 1020190181281 filed Aug. 30, 2019, each application of which cross-reference is hereby incorporated herein by reference in its entirety.

### TECHNICAL FIELD

The present invention relates, in general, to a new packaging material for agricultural products, such as cotton hay, straw and any other type of vegetable species of the foraging type, which are particularly packed in cylindrical bales through the use of automated agricultural machinery and equipment, such as self-propelled balers. These machines are able to travel in the field performing the harvest and, at the same time, forming bales with the harvested material, which are then properly packaged to be transported to the processing plants. Specifically, the aforementioned agricultural product packaging material was designed and developed to improve the working conditions of farmers, mainly to obtain a practical, functional, and low-cost solution for agricultural applications.

In addition, the present invention also addresses a method for producing such agricultural product packaging material.

### BACKGROUND

As already known in the state of the art, there are many ways to package agricultural products, such as cotton, hay, straw and fodder, which are normally harvested and grouped in bales to facilitate transport and processing outside the field. Many materials that can be used to bale these products, being configured and selected according to the characteristics and properties of the vegetable crop that is being harvested and packaged. As an example, materials formed by nets, tarpaulins and, in some cases, by the combination of nets and tarpaulins, which are usually plastics, such as polyethylene or polypropylene, are quite common.

According to the state of the art, with the development of numerous technologies applied in agriculture, it is known that there are several machines, pieces of equipment and devices usually applied to improve crop conditions, but mainly seeking to increase productivity in the field, be it at the time of planting or at harvest. In this context, we know some agricultural machines, also called harvesters or combines. They are self-propelled and capable of carrying out a continuous harvest without the need to make prolonged stops, or even to be removed from the field to, for instance, empty or transfer the material collected for transfers and/or trailers responsible for transporting the materials to places away from the field where they will be handled, processed and/or treated. Some machines, currently known and available in the market, make short stops in the field merely to dump cotton bales, for instance, in the case of automated cotton harvesters.

Particularly in the case of cotton harvesting, without discarding hay, straw and fodder in general, it is quite common to use plastic sheeting to pack the harvested material due to the need to keep the material grouped and protected from the weather. In addition, it facilitates the transport from the field to the material handling, processing and treatment sites, which are usually far from the planting and harvesting area. In addition, especially with regard to cotton harvesting, machines and equipment specially designed and developed to harvest this type of crop are known in the state of the art in view of the specificities and particularities that this type of plant culture requires, for instance, short crop durations and physical fragility in the face of bad weather.

These cotton-harvesting machines are capable of conducting a continuous harvest of the entire crop without long interruptions. Therefore, it is known that this type of machine has mechanisms that can harvest the material in the field. At the same time, it can store and package it, forming individual bales of the harvested material that can be dumped in the field and that, in due course, may be collected by a tractor or other appropriate piece of equipment, transported to the places where the harvested material is handled and processed. Thus, it as can be seen, the bales generated by this type of machine can optimize and, consequently, significantly increase the productivity levels of the crops, while ensuring the integrity of the harvested material. It must be considered that the tarpaulins used for these bales form plastic envelopes end up protecting the harvested material from the weather while they are scattered in the field.

It is worth remembering that this baling technology with tarps using automated machines managed to promote substantial advantages and improvements in the field has always been hard and cumbersome. In addition, it could manage to reduce the unhealthy work levels for workers and the workforce as a whole, since the harvest, especially of cotton. Often and easily, workers get hurt or sick, whether due to cuts in their hands, as well as due to weather conditions and extensive periods of work in the field. Therefore, with the arrival of these technologies, and the ability to somewhat automate the harvest, it became possible, in addition to improving the conditions of workers, to provide a significant increase in productivity while generating great benefits to society, from the perspective of human development.

In this sense, although these materials perform their functions, it was found that there were opportunities to improve and perfect their quality and strength, as well as to simplify the production lines to thereby eliminate flaws, problems and inconveniences that occurred with known materials in the state of the art to promote baling in automated machines, especially cotton, which requires a specific degree of care, as mentioned above.

More specifically, most of the materials known in the state of the art present drawbacks related to the production lines, which, in a way, interfere with the particularities required to allow automation in the stage of separating the material for packaging and at the moment of closing the bale made within said cotton harvesters or other products. This is because, as one may notice, the materials used to pack cotton, hay, straw and forage in automated machines are formed by segments of plastic tarpaulins interconnected by means of an adhesive element capable of keeping the segments interconnected and wrapped in a reel. That can be unrolled according to what is required by the harvester and, in the end, it must allow the separation of the subsequent segment and simultaneously, ensure the closure of the bale before being dumped on the field to be collected in due time.

In this context, the manufacturing process of these plastic tarpaulins for baling agricultural products in automated machines requires a step of assembling and connecting the segments that form a portion of packaging to then wrap this sequence of portions of individual packages in order to obtain a reel that will be coupled and used, for example, in automated cotton harvesters. As an example, the documents BRPI0307327-0, BRPI0511659-7, PCT/US2015/022330, PCT/AU2014/000821 and IN201303409 disclose plastic sheets formed by multiple segments fixed by means of connection and, thus, obtain a continuous film to be wound in a reel. These connection means are obtained by combining areas with and without adhesives that, in some cases, are folded to form a kind of protective layer that prevents the adhesive areas from gluing on the canvas when obtaining the reels and, thus, allow it to unwind inside the machines. In other cases, a stripe, tape or another equivalent mean is placed over the adhesive area to, in the same way, to prevent these areas from adhering to the canvas surfaces when the means is being rolled up during the formation of the reels.

As it must be appreciated by those skilled in the art, these adhesive areas were found to be relatively essential according to the knowledge and practices adopted until today. As the final stage of the formation of the cotton bales inside the machines, the end of the individual packaging portion had to be firmly and securely adhered to prevent the bales from opening when dumped in the field and, eventually, when subjected to weather conditions, (especially in the case of cotton, which is a material with a tendency to expand and, consequently, force the tarpaulin in order to promote its rupture and/or opening).

Therefore, as you can see, the process for manufacturing and assembling these reels is relatively complex, requiring, in some cases, steps that need a high level of precision to unite the segments and portions of packaging, which, logically, entails high manufacturing costs and, consequently, affects crop productivity and profitability.

The question of costs is even more problematic when it is observed that this material for the packaging and forming of agricultural product bales is usually discarded without providing any financial return to the farmer. As, due to the characteristics and properties of the materials used in manufacturing of these tarps, it is practically impossible to reuse and/or reintroduce this material in the production chain of these raw materials. More specifically, the tarps that are usually applied and known in the state of the art to pack agricultural products in automated machines are materials composed of thermoplastic resins with very low recycling capacity. For example, from the combination of PET, polypropylene, PVC and, as a more problematic factor, the use of acrylic based glues, which are a highly polluting material for the environment and, therefore, require special care to be handled and disposed of.

In this sense, the reuse of the material, or its recycling, ends up being a complex and expensive process, as it requires the use of a lot of water, solvents and experienced labor to not compromise the environment. In the end, these recycling processes end up resulting in a very weak material with very low value and little practical destination for the market, that is, there is a very restricted range of products that can be produced with this material.

For these reasons, materials known in the state of the art end up being used only to group and facilitate the transportation of the harvested material to the handling and processing sites, and cannot be reused in a new harvest or any other purpose that is effectively profitable for farmers.

Additionally, in some cases, some material models for agricultural product packaging known in the art had a drawback related to the separation of the packaging portions at the end of the baling process inside the machines. In some cases, the cut performed to separate the portions of individual packages is not accurate and, in most cases, this separation occurs by the mere stretching of the material until it breaks, resulting in a very uneven end with stretched parts that end up getting loose, without being not attached to the bale. These stretched and loose parts stimulate the weakening of the bale as a whole, mainly due to the influence of rain and winds that can help to open or break the bale spontaneously in the field, which leads to the loss of part of the harvested material and, consequently, to damages to the farmer.

As one may observe, these materials for agricultural product packaging in automated harvesting machines present problems, mainly at the last end of the packaging portion. These problems cans be caused either due to the need for a complex configuration that requires the application of adhesives and protectors to the adhesive areas, as well as the final configuration that effectively completes the baling process of the agricultural product to maintain the integrity of the harvested product, at least until it is transported to the handling and processing sites.

Thus, as we may seen, the solutions known in the state of the art for an agricultural product packaging material in automated harvesters, such as for the harvesting of cotton, hay, straw and fodder in general, presents problems, limitations and inconveniences from the processing complexity in the reel production lines, until the bales are finalized inside the machines and exposed to weather conditions, which also includes risks to the environment when the packaging material is disposed of.

In addition, from a more general point of view, it is understood that the technologies and solutions known in the state of the art to promote the baling of agricultural materials in automated machines reveal cost problems, but also restrictions that affect the quality and integrity of the material that is harvested in the field. It may even result in the loss and waste of materials in the field or during transportation, since they cannot guarantee the safe closing of the bales.

Thus, considering this scenario, these are, among others, the problems and inconveniences that are intended to be solved, or at least reduced, with the development of the present invention.

### Objects

In view of the above-mentioned context, it is one of the objectives of the present invention to provide a material for the packaging of agricultural products, such as cotton, hay, straw and fodder in general, and more particularly developed to be used in automated harvesting machines capable of carrying out the harvest and also baling the harvested material. Said packaging material, according to the present invention, comprises technical, constructive, structural and functional characteristics specially designed and developed to effectively solve the problems, limitations and inconveniences observed in the state of the art, as mentioned above.

Therefore, one of the objectives of the present invention is to provide a material for the packaging of agricultural products through automated harvesting machines that can substantially simplify the production lines, thus obtaining a reel formed by individual packaging portions that can be equally applied in said automated machines, but mainly able to carry out the baling process of the harvested material, and to maintain the integrity of the material regardless of the weather conditions to which said bale is exposed awaiting its transportation to the processing sites. More particularly, one of the objectives of the present invention is to provide a material that manages to ensure the integrity and quality of the material harvested, but in addition, it enables a reduction in the loss rates of the material harvested while in the in the field or in transportation, obtaining a substantial decrease in the waste rates for farmers.

Also, another objective of the present invention is to provide a material for the packaging of agricultural products that eliminates the need to apply permanent adhesives and, consequently, the requirement to have complementary elements to protect the adhesive areas when forming the reels that will be introduced in automated harvesting machines.

In addition, it is also an objective of the present invention to provide a material for the packaging of agricultural products that comprises constructive aspects that manage to ensure an ideal separation between the individual packaging portions in the final step of the baling process, as well as ensuring the closure of the bale safely in a way that reduces any risk of spontaneous opening of the bale due to rain or wind.

Therefore, one of the objectives of the present invention is to provide a material for packaging agricultural products inside an automated harvesting machine that has properties that improve and increase the level of protection of the harvested and baled material, whether in relation to the mechanical properties involving the structural aspects to support the grouped material, as well as physical properties with regard to protection against rain, sun, dirt, dust, etc.

The material for the packaging of agricultural products, which is the object of the present invention, also has the purpose of providing a product that can be easily recycled and reused for other purposes and, thus, eliminating environmental problems due to inappropriate disposal and without disposal after use. More specifically, according to a feature of the present invention, the packaging material is produced with materials that are totally non-toxic and can easily undergo recycling processes, for example, polyethylene-based materials. As such, it is able to provide a high capacity for reintegration of the material in the production chain, considering that this material, after disposal, can still be used in a multitude of applications and technological fields, such as production of rigid parts in the automotive sector and household appliances, hoses, or other applicable films in agriculture or civil construction.

More specifically, it is one of the objectives of the present invention, to provide a material for the packaging of agricultural products whose characteristics and properties eliminate the need to undergo separation steps and/or chemical treatments or additives to enable recycling, and can even be handled without risks to workers and the environment as it does not carry any toxic waste, including the type of non-permanent adhesive used that is water-based and, therefore, being easily and quickly absorbed by polyethylene without causing any damage to the environment.

It is worth mentioning that, according to this embodiment of the present invention, when produced with these non-toxic materials, it becomes possible to obtain benefits in terms of logistics and to have the product become more valuable in negotiations. This is because it is capable of providing an immediate installation of a program of collection and reuse of the material by the film manufacturers to improve the logistics of storage and dispensing of this material in the farms, that is, providing reverse logistics, which reflects in a social, cultural and environmental benefit.

In summary, the material for the packaging of agricultural products, object of the present invention, was designed and developed to, among other things, fully meet the cycle of use and destination of raw material, allowing its reintegration in the production lines of numerous technological sectors, including agriculture itself.

It is also one of the objectives of the present invention to provide a method for manufacturing said material for agricultural product packaging, which comprises steps designed and developed to simplify, but mainly to reduce the costs involved, while maintaining the properties required to meet the needs and particularities of the automated harvesting machines usually known and used in agriculture, particularly for harvesting cotton, hay, straw and forage.

### SUMMARY

Thus, in order to obtain the objectives, improvements and technical and functional effects mentioned above, among others, the present invention comprises a single continuous film that is composed of a plurality of portions of packaging, which are detachable from each other through a rupture line, said packaging portion being divided into an initial portion and a final portion, the latter portion being provided with a non-permanent adhesive layer on one of its surfaces.

According to an embodiment of the material for the packaging of agricultural products, which is the object of the present invention, said rupture line comprises a “V” configuration, said rupture lines being diagonally arranged and extending from the center of the end free from the initial portion of the packaging portion towards the side edges of said single continuous film. More particularly, according to a particular embodiment of the present invention, said diagonal rupture lines form an angle (a) with an imaginary transverse line (y) that can vary between 0^{Q} and 70^{Q}, and even more particularly as 30^{Q}.

According to possible embodiments of the present invention, said material for the packaging of agricultural products can comprise rupture lines whose configuration can be straight trapezoidal, wavy, arched, serrated, transverse blocks, elliptical, circular.

In addition, according to a further particular embodiment of the present invention, said material for packaging agricultural products may comprise reinforcement portions along the rupture lines that are made up of non-fragile segments and is intended to ensure the integrity of the material along production lines to provide the rupture and separation of packaging portions only in timely moments and during the harvesting processes in the field.

According to an embodiment of the present invention, said single, continuous film comprises, in the region of the rupture line, a narrowing in at least one of its lateral edges. Preferably, the single and continuous film comprises, in the region of the rupture line, a narrowing on both side edges. Also, according to a more particular embodiment of the present invention, this narrowing is formed by the combination of an angular narrowing and a complementary segment that provides conditions that end up directing and conditioning the bump between the portions of packaging in the aforementioned rupture line.

Also, according to another embodiment of the present invention, the single and continuous film is a multilayer plastic film with protection against ultraviolet rays, impermeable and with pigmentations, such as elements provided with properties and barriers against environmental and climatic interference, such as moisture, water, solids and oxygen.

According to an embodiment of the material for the packaging of agricultural products, the object of the present invention, said initial portion represents between 5% and 95% of the total extension of the packaging portion and the final portion represents between 5%-95% of the total extension of the packaging portion. Additionally, according to a preferred embodiment of the present invention, the initial portion represents 50% of the total length of the packaging portion and the final portion represents 50% of the total length of the packaging portion.

According to a particularly advantageous embodiment and intended for baling cotton and other fodder, the initial portion represents 45% of the total length of the packaging portion and the final portion represents 55% of the total length of the packaging portion. In addition, according to yet another embodiment of the present invention, the total length of the packaging portion comprises about 22 meters and, in this case, the initial portion is about 10 meters and the final portion is approximately 12 meters.

In addition, according to another particularly advantageous embodiment of the present invention, the rupture line is formed by weakening points, pre-breaking points and/or embrittlement points. Alternatively, this rupture line is obtained through laser tools, hot or cold metal knives, serrated cutting knives, straight cutting knives, pyramidal cutting knives, triangular cutting knives, or even as micro laser perforations or superficial embrittlement.

According to a further embodiment of the present invention, each packaging portion of said single continuous film comprises at least one indicator medium, which can be a photocell, an ink-based indication, a metallic paint, a metallic element, a marking, demarcation, barcode, or punch code.

Optionally, according to an alternative embodiment of the present invention, especially intended to increase the levels of harvest security, the packaging portion comprises at least one identifying means, which can be, for example, radio frequency tags-RFIDs.

According to an embodiment of the present invention, the single, continuous plastic film that forms the packaging portion is polyethylene-based, and said layer of non-permanent type adhesive is a water-based adhesive, which provides a more appropriate recycling and a lower risk of discarding materials that may contaminate the environment.

Also, in accordance with yet another optional embodiment of the present invention, said packaging portion might comprise at least one launch reinforcement, which is formed by labels applied to each initial portion of the packaging portion, the reinforcements being able to be arranged longitudinally or transversely in relation to the length of the single continuous film.

Also, in another optional embodiment of the present invention, the end of the final portion may be provided with at least one closure adhesive capable of keeping the material properly packed in the field.

Additionally, as mentioned above, the present invention also deals with a method to produce a material for the packaging of agricultural products that basically comprises the following steps:
a) producing a continuous plastic film, through the formulation of the raw material and preparation of the film extruder;
b) producing said continuous plastic film in jumbo-type reels, which are subjected to an inspection to be packaged and identified;
c) storing these jumbo-type reels to be applied in the production line of the unique and continuous plastic film of the present invention, and comprising the steps of:
   c.1) unwinding said jumbo-type reel;
   c.2) positioning and applying the signaling means, such as a metal label;
   c.3) said continuous plastic film receives a rupture line, which is responsible for projecting portions of packages, said rupture line being placed between the final portion of a packaging portion and the initial portion of the subsequent packaging portion formed by said continuous plastic film; c.4) intermittent application of a layer of adhesive of the non-permanent type on one of the surfaces of the continuous plastic film, forming an initial portion without adhesive and a final portion containing said non-permanent adhesive; c.5) subject the continuous plastic film to a drying and absorption process of the non-permanent adhesive in a greenhouse; c.6) wrapping said continuous plastic film in a reel to be introduced in an automated harvester;
d) inspection of reels of continuous plastic film to be packaged and identified;
e) storing said reel of continuous plastic film.

According to a preferred embodiment of the present invention, during said step (c.4) the proportion between the initial and final portions are equivalent and comprise, respectively, 50% of the total length of a packaging portion. Alternatively, according to another possible embodiment of the present invention, the final portion, the surface of which is coated with a layer of adhesive of the non-permanent type, represents between 5% and 95% of the total length of the packaging portion. Also, according to a preferably advantageous embodiment of the present invention, the initial portion represents around 45% of the total length of the packaging portion and the final portion represents around 45% of the total length of the packaging portion. In addition, according to yet another embodiment of the present invention, the total length of the packaging portion comprises about 22 meters and, in this case, the initial portion is about 10 meters and the final portion is approximately 12 meters.

In addition, in accordance with yet another embodiment of the present invention, step (c.3) is conducted through a process of forming embrittlement points, pre-rupture points and/or weakening points. Optionally, at this stage (c.3), this rupture line is obtained through laser tools, with hot or cold metal knives, serrated cutting knives, straight cutting knives, pyramidal cutting knives, triangular cutting knives, with micro laser perforations or superficial embrittlement.

According to a particular and advantageous embodiment of the method of the present invention, during said step (c.3), the rupture line that is formed in said continuous plastic film, comprises a “V” configuration, which is formed by the arrangement of said rupture lines diagonally, so that they extend from the center of the free end of the initial portion of the packaging portion towards the side edges of said single continuous film. More particularly, according to a particular embodiment of the present invention, said diagonal rupture lines form an angle (a) with an imaginary transverse line (y) that can vary between 0^{Q} and 70^{Q}, and even more particularly this angle (a) is of 30^{Q}.

In addition, according to a further possible embodiment of the present invention, during step (c.3) the rupture lines can be formed with straight, wavy, arched, serrated, transverse, elliptical, circular or trapezoidal type configurations.

According to another embodiment of the method of the present invention, during said step (c.3) it is possible to provide for the formation of reinforcement portions, which are made up of non-fragile segments along said rupture lines.

In addition, according to an alternative embodiment of the method of the present invention, a step is provided (c.2.a) to form a strand of at least one edge of the continuous plastic film in order to obtain and form a narrowing in the region of the rupture line between the portions of individual packages. More particularly, according to an embodiment of the present invention, during that step (c.2.1), this strand forms a narrowing that is configured through the combination of an angular narrowing and a complementary segment.

More specifically, according to other embodiments of this invention, during stage (c.2), the indicator medium can be a photocell, an ink-based indication, a metallic paint, a metallic element, a marking, demarcation, barcode, or punch code.

In addition, according to yet another optional embodiment of the method of the present invention, after step (c.5), the continuous plastic film is subjected to a step of including at least one identifying medium, for example, RFID tags-RFIDs.

According to a further optional embodiment of the method of the present invention, it is possible to include a step of applying at least one launch reinforcement on the packaging portion, the reinforcement being a label applied adjacent to the edge of each initial portion and is arranged transversely or longitudinally in relation to the extension of the single continuous film.

### BRIEF DESCRIPTION OF THE DRAWINGS

The characteristics, advantages and technical effects of the present invention, as outlined above, will be better and more appropriately understood by a person skilled in the art based on the detailed description below, made by way of example, and not restrictively, of preferred embodiments, and with reference to the attached schematic figures, in which:

FIG. 1 shows a top perspective view of a reel of material for the packaging of agricultural products, according to a first embodiment of the present invention, partially unwound;

FIG. 2 shows a top perspective view of a reel of material for the packaging of agricultural products, according to an alternative embodiment of the present invention, partially unwound;

FIG. 3 shows a side view of an embodiment of the material for the packaging of agricultural products, the objective of the present invention;

FIG. 4A shows a top view of another optional embodiment of the embrittlement region between the portions of individual packages, according to the present invention;

FIG. 4B shows a top view of another optional embodiment of the embrittlement region between the portions of individual packages, according to the present invention;

FIGS. 5A and 5B show top views of other embodiments of the material for the packaging of agricultural products, according to the present invention;

FIG. 6A schematically represents a production line for a material for the packaging of agricultural products according to the present invention;

FIG. 6B shows a block diagram/flow chart of the main steps of the method for producing the material for the packaging of agricultural products, according to the present invention.

### DETAILED DESCRIPTION OF THE EMBODIMENTS

According to what was reported above, some examples of particular and possible embodiments of the present invention will be described in more detail below. However, it is important to note that this is a purely exemplary and non-restrictive description, since the material to pack agricultural products, as well as the method linked to it, may present different details and technical and constructive characteristics without, therefore, affecting the scope of protection defined by the attached claims.

In this context, it is worth reiterating that the following description will be made with reference to the attached figures, which are schematic and seek only to exemplify and facilitate the interpretation and understanding of the present invention. Thus, it is important to emphasize that the dimensions and/or proportions may not reflect reality, because they seck only to present the invention in the most didactic way possible. In addition, some known and common details may have been omitted to improve the clarity and conciseness of the present description.

Thus, given the scenario presented above, and particularly as represented by the attached figures, the material for the packaging of agricultural products is designed and developed to be used especially in automated agricultural machines, such as cotton harvesters, hay, straw and forage plants in general. These machines are capable of harvesting in the field and also pack the harvested material in bales that are sequentially dumped in the field so that another machine or equipment can collect and transport these bales to the processing sites.

Thus, it can be stated that said material for packaging agricultural products is formed by a single continuous film 1 which is composed of a plurality of portions of packaging 2, detachable from each other through a rupture line 3, said packaging portion 2 is divided into an initial portion 2a and a final portion 2b, the latter having one of its surfaces coated with a layer of non-permanent type adhesive 4.

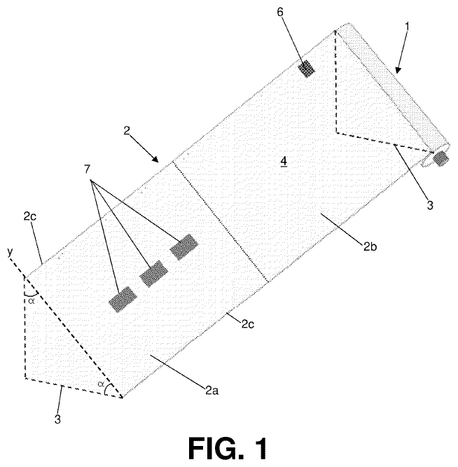

According to one of the embodiments of the material for the packaging of agricultural products, object of the present invention, and as shown in FIG. 1, this rupture line 3 comprises a “V” configuration, that is, it is formed by the arrangement of diagonal rupture lines extending from the center of the free end of the initial portion 2a towards the side edges 2c of said single continuous film 1.

More particularly, according to a particular embodiment of the present invention, said diagonal rupture lines form an angle (a) with an imaginary transverse line (y) that can vary between 0^{Q} and 70^{Q}, and even more particularly this angle (a) is of 30^{Q}.

According to a particularity of this first embodiment, it is worth noting that the end of the final portion 2b forms a fishtail-like configuration that corresponds to the “V” configuration of the end of the initial portion 2a and, from that outside. It is reiterated that the material for the packaging of agricultural products of the present invention is comprised of a single, continuous film 1 that does not have any type of splice or joint of packaging portions 2 and is therefore quite different from the materials known in the prior art.

According to an alternative and optional embodiment of the present invention, and in particular, but not limited to this situation, in the case of the embodiment in which said rupture lines are arranged at an angle (a) equal to zero, that is, the rupture lines 3 comprise a straight configuration extending between the lateral edges 2c, said single continuous film 1 may comprise, in the region of that rupture line 3, a narrowing 5 in at least one of its lateral edges 2c and, preferably, on both side edges 2c. The purpose of this narrowing 5 is to promote conditioning and direct the rupture of the single continuous film 1 in order to guide the separation of the portions of packaging 2 with a low risk of forming burrs when separating the portions and closing the bale. In addition, this narrowing 5 may eventually assist in the conditions of adherence in the final stage of packing and bale formation, in order to ensure that the bale is firmly locked in place.

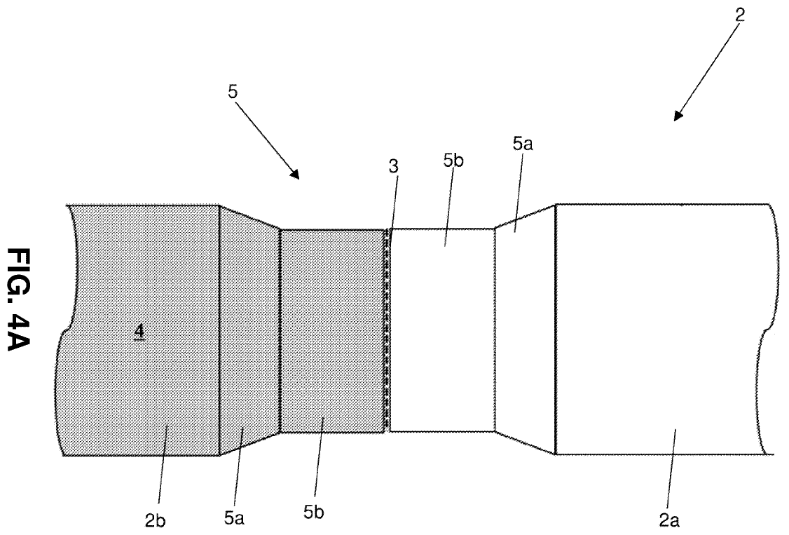

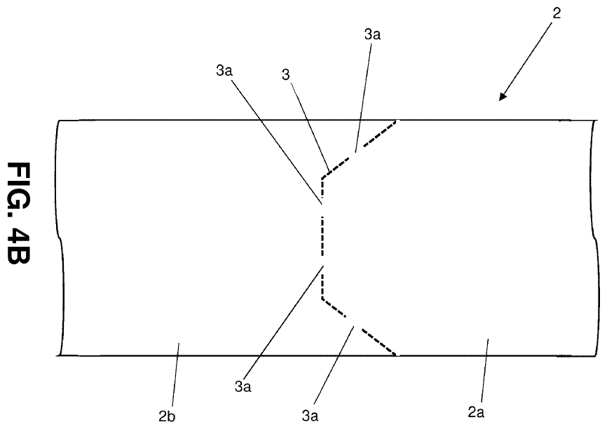

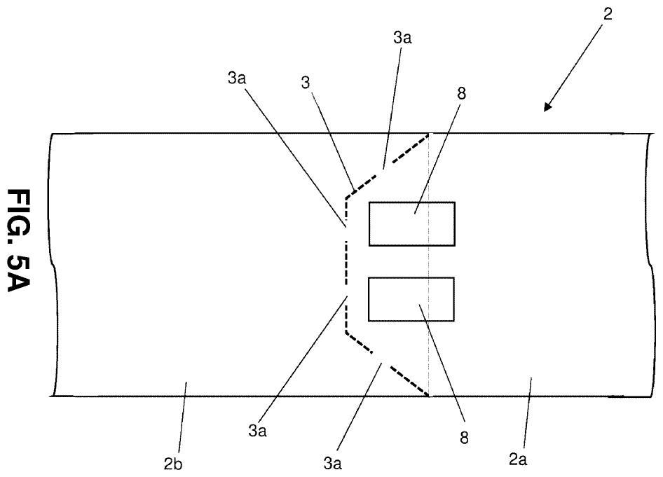

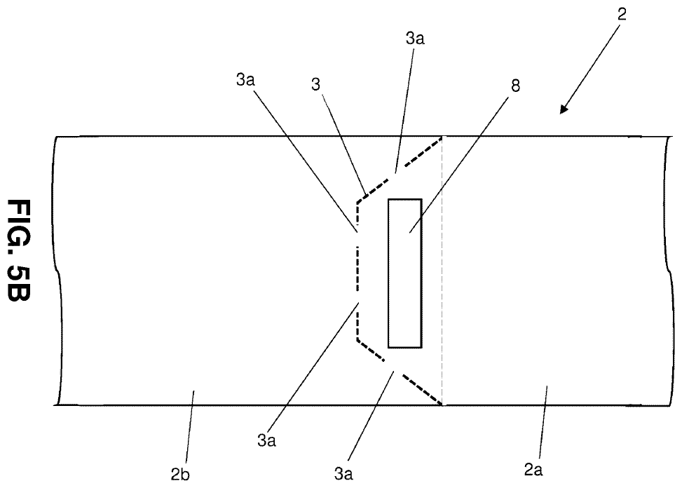

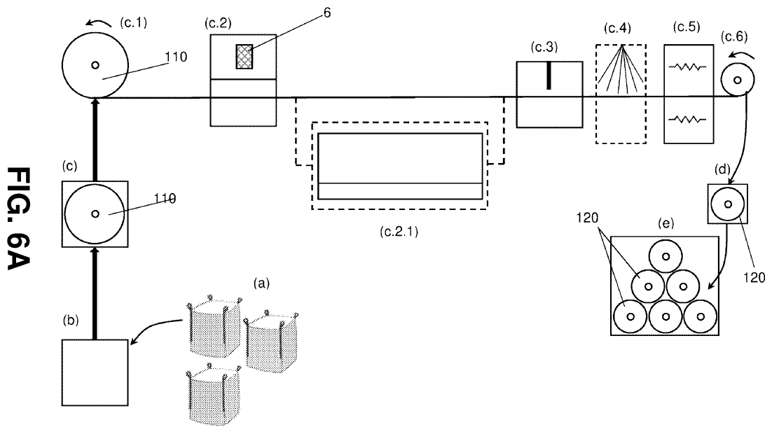

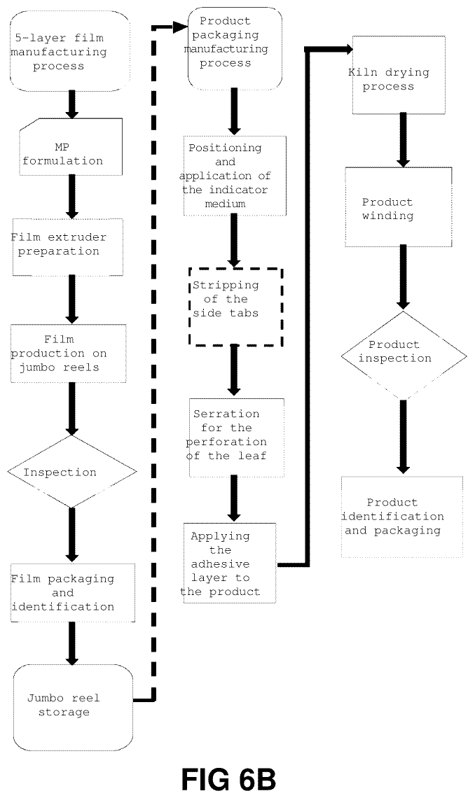

According to another alternative embodiment of the present invention, and as shown in FIG. 4A, that narrowing 5 can be formed by combining an angular narrowing 5a and a complementary segment 5b to thereby assist in conditioning and directing the break and, also, to form a configuration that can improve the adhesion conditions in the final stage of packaging and bale formation.

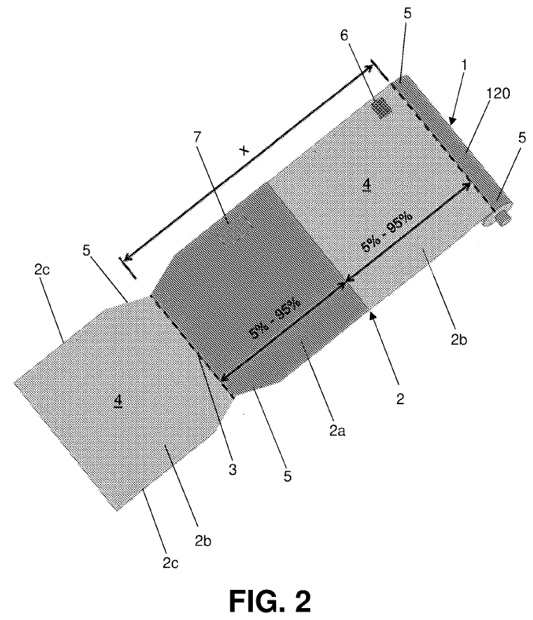

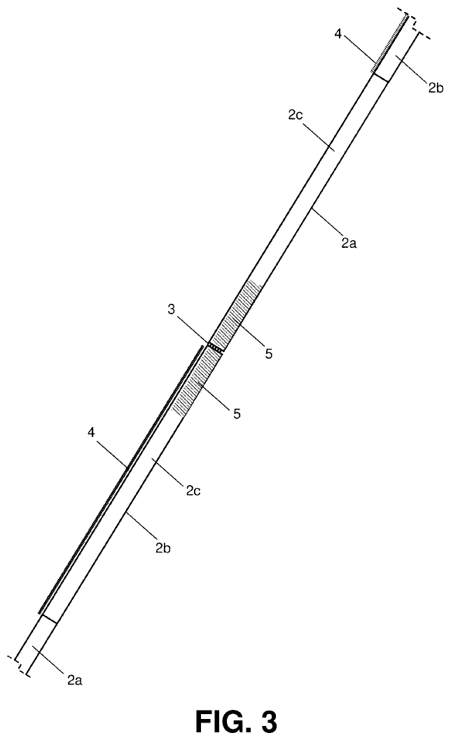

As it should be appreciated by persons skilled in the art, although FIGS. 2 and 4A illustrate representations in which the rupture lines 3 are relatively straight in cases where there is the said narrowing 5, it is possible to predict combined embodiments without any prejudice to the scope of protection now claimed, allowing, in this sense, for said rupture lines 3 to be, for instance, arranged diagonally in embodiments so that said single continuous film 1 is provided with narrowing 5 at its lateral edges 2c.

Particularly with respect to the representation of FIG. 4B, it is possible to observe an embodiment of the present invention in which the embrittlement region comprises the rupture line 3 in trapezoidal shape, that is, a configuration similar to that shown in FIG. 1, but with the “tip of the arrow” being formed by a straight segment. In brief, optionally, it is possible to highlight that numerous configurations different from those disclosed in the figures can be easily applied by a person skilled in the art, among which, one could mention as an example: “V” shape, trapezoidal, straight, undulate, arched, serrated, transverse blocks, elliptical, circular, etc.

In addition, according to another possible embodiment of the present invention, and as shown by way of example in FIG. 4B, said rupture lines 3 can comprise reinforcement portions 3a, which are constituted by non-fragile segments along the rupture line 3, the purpose of these reinforcement portions 3a being to ensure the integrity of the single continuous film 1 during the production process, while providing the proper rupture of line 3 and separation of the packaging portions at the appropriate time within the harvesters in the field.

Also, according to another embodiment of the present invention, said single and continuous film 1 is a multilayer plastic film containing layers responsible for protection against ultraviolet rays, impermeability and with pigmentation to improve the internal conditions of the bale when exposed to heat, cold and moisture. More particularly, the single continuous film 1 is characterized by the presence of barriers against these environmental and climatic interferences, such as humidity, water, solids, oxygen, etc. As it should be appreciated, the plastic film, according to the present invention, has the ability to waterproof and secure the agricultural product as if it were in a package or wrapper capable of keeping the harvested agricultural product mass cohesive, especially free of any contaminants that may devalue the harvested material.

Another characteristic of the material for packaging agricultural products, according to the object of the present invention, is in relation to the proportion between the initial portions 2a and final 2b, which can be the same, that is, each of said portions representing 50% of the extension total (x) of the packaging portion 2. Alternatively, the referred portions represents 95% and 5%, or vice versa; which means that the final portion 2b, whose surface is covered with a layer of a type 4 non-permanent adhesive, can represent between 5% and 95% of the total extension (x) of the packing portion 2.

According to a particularly advantageous embodiment intended for baling cotton and other fodder, the initial portion 2a represents about 45% of the total length (x) of the packaging portion 2 and the final portion 2b represents 55% of the total length (x) of the packaging portion 2. Furthermore, according to yet another preferred embodiment of the present invention, the total length (x) of the packaging portion comprises about 22 meters and, in this case, the initial portion 2a is about 10 meters and the final portion 2b is approximately 12 meters.

In addition, according to another particularly advantageous embodiment of the present invention, the aforementioned rupture line 3, provided between packaging portions 2 of the single and continuous film 1, is comprised by weakening points, pre-breaking points and/or embrittlement points. Alternatively, this rupture line 3 can be obtained through laser tools, hot or cold metal knives, serrated cutting knives, straight cutting knives, pyramidal cutting knives, triangular cutting knives, or even as micro laser perforations, superficial embrittlement or any other equivalent means.

According to a preferred embodiment of the present invention, each packaging portion 2 of the single continuous film 1 comprises at least one signaling medium 6 responsible for promoting some type of interaction with the internal mechanisms of the automated machines, particularly, to allow the proper unwinding of the reels, winding of the bales and rupture of said packaging portions 2 exactly at break line 3. More preferably, according to constructive variants of the present invention, said indicator means 6 can be a photocell, an ink-based indication, a metallic paint, a metallic element, a marking, a demarcation, a barcode, a punch code, or any other element capable of promoting the indication of the length of said packaging portion 2 unwound inside the machine.

Optionally, in accordance with yet another embodiment of the present invention, said packaging portion 2 comprises at least one identifying means 7 whose purpose is to provide the geographical identification of the bales in the field when they are dumped by automated machines and await collection for transport to the processing sites. These identifying means can significantly assist the logistics of fieldwork, ensuring that all bales generated in the field by automated machines have been properly collected and transported to processing units, thereby preventing theft, robberies, diversion and loss of agricultural products. For example, these means of identification may be radio frequency tags, such as RFID tags, or any other technology capable of promoting this geographical identification and the monitoring of the bales.

According to an embodiment of the present invention, said single, continuous plastic film 1 forming the packaging portion 2 is polyethylene-based and said layer of adhesive of the non-permanent type 4 is a water based adhesive.

According to another possible and alternative embodiment of the present invention, said packaging portion 2 comprises at least one release reinforcement 8 whose purpose is to provide better conditions for the beginning of the process of packaging agricultural products on machines, and more specifically to promote a reinforcement in the initial conformation of the bales. More preferably, this release reinforcement 8 is a label that can be applied to the initial portion 2a of each packaging portion 2. It is worth mentioning that this release reinforcement 8 improves the working conditions of the agricultural machine, to ensure that the initial packaging portion 2a is pulled and driven in an adequate and safe way by the internal rollers of the machine and, thus, guaranteeing the initial conformation of the bale in a more appropriate and safe condition. According to alternative variants of this embodiment, said release reinforcement, eight can be labels placed transversely or longitudinally in relation to the extension of the single continuous film 1.

Also, for the purely optional purpose of the present invention, said single, continuous plastic film 1, more particularly at the end of the final portion 2b, may comprise a sealing adhesive responsible for promoting the bale locking with the harvested agricultural product.

Additionally, as mentioned above, the present invention also deals with a method to produce a material for the packaging of agricultural products that basically comprises the following steps:
a) producing a continuous plastic film 1, through the formulation of the raw material and preparation of the film extruder;
b) producing said continuous plastic film in jumbo-type reels 110, which are subjected to an inspection to be packaged and identified;
c) storing these jumbo-type reels 110 to be applied in the production line of the single and continuous plastic film 1 and comprising the steps of:
   c.1) unwinding said jumbo-type reel 110; c.2) positioning and applying the indicator means 6, such as a metallized label;
   c.3) said continuous plastic film 1 receives a rupture line 3, which is responsible for projecting portions of packages 2, said rupture line 3 is placed between said final portion 2b of a packaging portion 2 and the portion initial 2a of the subsequent packaging portion 2 formed by said continuous plastic film 1;
   c.4) intermittent application of a non-permanent adhesive layer 4 on one of the surfaces of the continuous plastic film 1, forming an initial portion 2a without adhesive and a final portion 2b containing said non-permanent type adhesive 4;
   c.5) submitting the continuous plastic film to a drying and absorption process of the non-permanent adhesive 4 in an oven;
   c.6) rewinding said continuous plastic film 1 on a reel 120 to be fed into an automated harvester;
d) inspection of reels 120 of continuous plastic film 1 to be packaged and identified;
e) storing said reel 120 of continuous plastic film 1.

According to a preferred embodiment of the present invention, during said step (c.4) the proportion between the initial 2a and final 2b portions are equivalent and comprise, respectively, 50% of the total length (x) of a packaging portion 2. Alternatively, according to another possible embodiment of the present invention, said final portion 2b, the surface of which is coated with a layer of adhesive of the non-permanent type 4, represents between 5% and 95% of the total length (x) of the packaging portion 2. In addition, according to a preferably advantageous embodiment of the present invention, especially for the application of cotton harvesters, the initial portion 2a represents around 45% of the total length (x) of the packaging portion 2 and the final portion 2b represents around 45% of the total length (x) of the packaging portion 2. Furthermore, according to yet another preferred embodiment of the present invention, the total length (x) of the packaging portion comprises about 22 meters and, in this case, the initial portion 2a is about 10 meters and the final portion 2b is approximately 12 meters.

In addition, in accordance with yet another possible embodiment of the present invention, the aforementioned step (c.3) related to the obtaining of a rupture line 3 is conducted through a process of forming embrittlement points, pre-rupture points and/or weakening points. This rupture line 3 is obtained, optionally, through laser tools, hot or cold metal knives, serrated cutting knives, straight cutting knives, pyramidal cutting knives, triangular cutting knives, or even as micro laser perforations, superficial embrittlement or any other equivalent means allowing the separation of said packaging portions 2.

According to one of the embodiments of the method for the production of a material for the packaging of agricultural products, during said stage (c.3), said rupture line is formed so as to provide a “V” configuration, that is, it is formed by the arrangement of diagonal rupture lines 3 extending from the center of the free end of the initial portion 2a towards the side edges 2c of said single continuous film 1. More particularly, according to a particular embodiment of the method of the present invention, said diagonal rupture lines 3 are obtained considering an angle (a) with an imaginary transverse line (y) that can vary between 0^{Q} and 70^{Q}, and even more particularly this angle (a) amounts to 30^{Q}.

Optionally, according to another embodiment of the method of the present invention, during said step (c.3), the rupture line 3 is formed in order to provide a trapezoidal configuration, that is, a configuration similar to that shown in FIG. 1, but with the “arrowhead” being formed by a straight segment. In brief, optionally, it is possible to highlight that numerous configurations different from those disclosed in the figures can be easily formed in this method, among which, one could mention as an example: “V” shape, trapezoidal, straight, undulate, arched, serrated, transverse blocks, elliptical, circular, etc.

Additionally, according to a variant of the method of the present invention, during the formation of the rupture line 3 in step (c.3) there is the formation of reinforcement portions 3a, which are made up of non-fragile segments along the break line 3.

According to an alternative to the present method of producing a material for packaging agricultural products, among the aforementioned stages of application of indicator medium 6 (c.2) and formation of the rupture line 3 (c.3), it is possible to include a step (c.2.1) to provide the trimming of at least one of said lateral edges 2c to obtain and form a narrowing 5 in the region where said rupture lines 3 will be formed.

Also, according to another embodiment of the method of the present invention, in said step (c.2.1), the cut performed for the stripping of said continuous plastic film 1 is carried out on the two edges 2c to thereby provide a configuration that helps with the cutting and separation of the packaging portions 2. More particularly, according to an embodiment of the present invention, during step (c.2.1) said stripping occurs so as to form a narrowing 5 that is configured by combining an angular narrowing 5a and a complementary segment 5b to thereby help in the direction of the rupture, while forming a configuration that helps with the adhesion conditions in the final stage of packing and bale formation.

Particularly, according to constructive variants of the present invention, during stage (c.2), said indicator means 6 can be a photocell, an ink-based indication, a metallic paint, a metallic element, a marking, a demarcation, a barcode, a punch code, or any other element capable of promoting the indication of the length of said packaging portion 2 unwound inside said machines.

Also, according to another embodiment of the method of this invention, after stage (c.5), said continuous plastic film 1 is subjected to the stage of inclusion of at least one identifying means 7 whose purpose is to provide the geographical identification of the bales in the field when they are dumped by automated machines and await collection for transport to the processing sites. As mentioned above, these indicator means 7 help with the logistic of agricultural work, ensuring that all bales generated in the field by automated machines have been properly collected and transported to processing units, thereby preventing theft, robberies, diversion and loss of agricultural products. For example, these means of identification may be radio frequency tags, such as RFID tags, or any other technology capable of promoting this geographical identification and the monitoring of the bales.

Furthermore, according to a further optional embodiment of the method of the present invention, it is possible to include a step of applying at least one release reinforcement 8 on the packaging portion, the reinforcement 8 being a label preferably applied adjacent to the edge of each initial portion 2a. According to alternative variants of this stage, said release reinforcement, eight can be labels placed transversely or longitudinally in relation to the extension of the single continuous film 1.

Finally, in view of all the above, one must understand that the present description has the sole purpose of defining, by way of example, preferred embodiments of the material for the packaging of agricultural products developed to be applied in automated harvesting machines, as well as to the methods related to the manufacture of said material and packaging using this packaging material, according to the present invention. Therefore, as the technicians in the subject understand, numerous modifications, variations and constructive combinations of the elements that perform the same function in substantially the same way are possible in order to achieve the same results, and that must be included within the scope of protection defined by the attached claims.

1. A material for the packaging of agricultural products, comprising a single continuous film that is composed of a plurality of packaging portions, which are detachable from each other through a rupture line, said packaging portion being divided into an initial portion and a final portion, the latter portion being provided with a non-permanent adhesive layer on one of its surfaces.

2. The material for the packaging of agricultural products according to claim 1, characterized by the fact that said rupture line comprises a “V” configuration, in which said rupture lines are arranged diagonally and extend from the center of the free end of said initial portion towards the lateral edges of said single continuous film.

3. The material for the packaging of agricultural products according to claim 1, characterized by the fact that along said rupture lines there are reinforcement portions that are made up of non-fragile segments.

4. The material for the packaging of agricultural products according to claim 1, characterized by the fact that said single and continuous film comprises, in the region of said rupture line, a narrowing in at least one of its side edges.

5. The material for the packaging of agricultural products according to claim 1, characterized by the fact that said single and continuous film comprises, in the region of said rupture line, a narrowing on both side edges.

6. The material for the packaging of agricultural products according to claim 1, characterized by the fact that the single and continuous film is a multilayer plastic film with protection against ultraviolet rays, impermeable and with pigmentations, such as elements provided with properties and barriers against environmental and climatic interference, such as moisture, water, solids and oxygen.

7. The material for the packaging of agricultural products according to claim 1, characterized by the fact that said rupture line is formed by embrittlement points, pre-rupture points and/or weakening points.

8. The material for the packaging of agricultural products according to claim 1, characterized by the fact that each packaging portion of said single continuous film comprises at least one indicator medium, which can be a photocell, an ink-based indication, a metallic paint, a metallic element, a marking, demarcation, barcode, or punch code.

9. The material for the packaging of agricultural products according to claim 1, characterized by the fact that said packaging portion comprises at least an identifier medium, such as RFID tags.

10. The material for the packaging of agricultural products according to claim 1, characterized by the fact that said single, continuous plastic film forming the packaging portion is polyethylene-based and said layer of adhesive of the non-permanent type is a water based adhesive.

11. The material for the packaging agricultural products according to claim 1, characterized by the fact that said packaging portion comprises at least one release reinforcement that is formed by labels applied in each initial portion longitudinally or transversely in relation to the length of the single continuous film.

12. The material for the packaging of agricultural products according to claim 1, characterized by the fact that the end of the final portion comprises a closing adhesive.

13. A method of production of a material for the packaging of agricultural products, characterized by comprising the following steps:
a) producing a continuous plastic film, through the formulation of the raw material and preparation of the film extruder;
b) producing said continuous plastic film in jumbo-type reels, which are subjected to an inspection to be packaged and identified;
c) storing these jumbo-type reels to be applied in the production line of the single and continuous plastic film and comprising the steps of:
c.1) unwinding said jumbo-type reel;
c.2) positioning and applying the signaling means, such as a metallic label;
c.3) said continuous plastic film receives a rupture line, which is responsible for projecting portions of packages, said rupture line being placed between said final portion of a packaging portion and the initial portion of the subsequent packaging portion formed by said continuous plastic film;
c.4) intermittent application of a non-permanent adhesive layer on one of the surfaces of the continuous plastic film, forming an initial portion without adhesive and a final portion containing said non-permanent type adhesive;
c.5) subjecting the continuous plastic film to a drying and absorption process of the non-permanent adhesive in an oven;
c.6) rewinding said continuous plastic film in a reel to be introduced in an automated harvester;
d) inspection of reels of continuous plastic film to be packaged and identified;
e) storing said reel of continuous plastic film.

14. The method according to claim 13, characterized by the fact that, step (c.3) is conducted through a process of forming embrittlement points, pre-rupture points and/or weakening points.

15. The method according to claim 13, characterized by the fact that in said stage (c.3), the rupture line comprises a “V” configuration, in which said rupture lines are arranged diagonally and extend from the center of the free end of said initial portion towards the lateral edges of said single continuous film.

16. The method according to claim 13, characterized by the fact that during step (c.3) there is the formation of reinforcement portions, which are made up of non-fragile segments along the rupture line.

17. The method according to claim 13, characterized by the fact that it additionally comprises a step (c.2.1) to form a profile of at least one edge for obtaining and forming a narrowing in the region of the rupture line of the packaging portion.

18. The method according to claim 13, characterized by the fact that during said step (c.2) the indicator medium is a photocell, an ink-based indication, metallic paint, metallic element, marking, demarcation, barcode or punch code.

19. The method according to claim 13, characterized by the Fact that after step (c.5), the continuous plastic film is subjected to a step of including at least one identifying medium, for example RFID tags-RFIDs.

20. The method according to claim 13, characterized by the fact that it additionally comprises a step of applying at least one release reinforcement on the packaging portion, with said reinforcement being a label applied adjacent to the edge of each initial portion and disposed transversely or longitudinally in relation to the extension of said single and continuous film.
